(19) United States
(12) Patent Application Publication
(10) Pub. No.: US 2021/0298227 A1
(43) Pub. Date: Sep. 30, 2021

(54) MULTI-ROW PLANTER WITH SYNCHRONIZED SEED DROP

(71) Applicant: Seed Research Equipment Solutions, LLC, South Hutchinson, KS (US)

(72) Inventor: Stacy L. Unruh, Haben, KS (US)

(21) Appl. No.: 17/216,230

(22) Filed: Mar. 29, 2021

Related U.S. Application Data
(60) Provisional application No. 63/000,638, filed on Mar. 27, 2020.

(51) Int. Cl. A01C 7/12; A01C 7/10

(52) U.S. Cl. CPC A01C 7/125; A01C 7/105

(57) ABSTRACT

An agricultural planter has a plurality of planter row units spaced across a width of the planter, and release mechanisms for releasing seeds or plants into the ground from each row unit. A positioning system determines a location of the planter in a field, and a controller uses the location information to cause the release mechanism to release seeds or plants at predetermined tripping points in the field. The release mechanisms of all of the planter row units are moved simultaneously as the planter reaches each tripping point location in the field. This allows the seeds or plants from all of the row units to be released in a synchronized manner and aligned in a lateral direction relative to a direction of travel of the planter while planting. In one embodiment, the release mechanisms are positioned near lower ends of seed delivery tubes that receive seeds from seed metering mechanisms.

### RELATED APPLICATIONS

This application claims the benefit of U.S. Provisional Patent Application No. 63/000,638 filed on Mar. 27, 2020. The entire content of such provisional application is incorporated herein by reference.

### TECHNICAL FIELD OF THE INVENTION

The present invention relates generally to seed planters, and in particular to seed planters used for planting research plots and other row crop planters used for planting or transplanting seeds and plants in a grid-shaped pattern of rows.

### BACKGROUND ART

Seed research plot fields are commonly used by researchers to obtain yield and growth data for different seed types. Such fields typically contain several individual seed plots arranged in the same field, with each plot containing one or more rows and with alleyways separating the end of the rows of one plot from the beginning of the rows of the next plot. The plot fields are typically planted using a planter that plants multiple plots with alleyways between each plot during each pass of the planter through the field.

Special planters have been developed for planting research plot fields. For example, U.S. Pat. Nos. 6,615,754, 8,948,976, 9,622,403 and 10,091,928 assigned to Seed Research Equipment Solutions, LLC provide examples of such planters.

Conventional row crop seed planters, including but not limited to research plot seed planters, have multiple row units spaced across a width of the planter for planting seeds in rows. Each row unit includes a seed metering system for singulating and dropping seeds in the longitudinal rows at spaced intervals according to a desired seed spacing/population set by the user. The metering systems may be driven by drive chains and/or electric or hydraulic drive motors.

### SUMMARY OF THE INVENTION

### Technical Problem

There is a need in the industry for a multi-row planter that provides a synchronized drop of seeds or plants from each row unit across the width of the planter to provide aligned rows of seeds or plants in both longitudinal and lateral directions relative to the direction of planting.

There is a further need for a planter having a controller and a field layout system that allows a user to set a seed or plant spacing and provide a synchronized seed or plant drop across a width of the planter while planting a field.

There is a further need for a planter that drops seeds or plants from each row unit in a synchronized pattern to provide uniform rows in both a longitudinal direction and a lateral direction relative to the direction of planting.

There is a further need for a planter that uses a positioning system to trigger when each seed or plant is placed into the ground, thereby ensuring that the seeds or plants will be in a uniform grid pattern across the field.

There is a further need for a planter control system that allows multiple row units to meter seeds into a seed tube or other seed delivery structure and uses a seed drop gate near the outlet of the seed tube or seed delivery structure to control the precise time or location when the seed is released into the seed furrow.

### Solution to Problem

An agricultural planter according to the present invention has a plurality of planter row units spaced across a width of the planter, and release mechanisms for releasing seeds or plants into the ground from each row unit. A positioning system determines a location of the planter in a field, and a controller uses the location information to cause the release mechanism to release seeds or plants at predetermined tripping points in the field. The release mechanisms of all of the planter row units are moved simultaneously as the planter reaches each tripping point location in the field. This allows the seeds or plants from all of the row units to be released in a synchronized manner and aligned in a lateral direction relative to a direction of travel of the planter while planting.

In one embodiment, the release mechanisms are positioned near lower ends of seed delivery tubes that receive seeds from seed metering mechanisms so that the seeds are first singulated and metered out into the seed tubes and then held near the bottom of the seed tubes until they are released by a release gate. The release gates of all of the rows are opened simultaneously when the planter reaches a tripping point in the field, as determined by a GPS receiver, to create aligned rows in both longitudinal and lateral directions of the planter relative to the direction of planting.

According to one aspect of the invention, an agricultural planter is provided, comprising: a plurality of planter row units spaced across a width of the planter, each row unit comprising a metering mechanism for dropping seeds or plants into a delivery structure that guides the seeds or plants from the metering mechanism into the ground. The delivery structures each have a respective drop gate with a first closed position in which the drop gate blocks a lower outlet of the delivery structure, and a second open position in which the drop gate allows a seed or plant to exit from the lower outlet of the delivery structure. A positioning system determines a location of the planter in a field; and a controller causes the drop gates of the plurality of planter row units to simultaneously move from their first closed positions to their second open positions to provide a synchronized release of seeds or plants from all of the row units when the positioning system determines that the planter is at a predetermined tripping position in a field.

According to another aspect of the invention, an agricultural planter is provided, comprising: a plurality of planter row units spaced across a width of the planter, each row unit comprising a furrow opener for creating a furrow, a seed tube for guiding seeds into the furrow, and a seed metering mechanism for singulating and dropping seeds into the seed tube. A plurality of seed drop gates are arranged to selectively close lower outlets of the seed tubes, the seed drop gates being movable between first closed positions in which the lower outlets are blocked, and second open positions in which the lower outlets are open to allow seeds to exit from the seed tubes.

According to another aspect of the invention, an agricultural planter is provided, comprising: a plurality of planter row units spaced across a width of the planter, each row unit comprising a release mechanism for releasing seeds or plants into the ground; a positioning system that determines a location of the planter in a field; and a controller that causes the release mechanism to release seeds or plants from the planter row units simultaneously as the planter reaches predetermined locations in the field determined by the positioning system. The seeds or plants from all of the row units are released in a synchronized manner and aligned in a lateral direction relative to a direction of travel of the planter while planting.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a research plot planter being pulled by a tractor through a research plot field.

FIG. 2 is an illustration of some of the components of the research plot planter, including a seed meter assembly, a hydraulic drive motor for driving the seed meter assembly, a control valve for controlling the hydraulic drive motor, and a seed drop gate positioned near the outlet of the seed tube.

FIG. 3 is a side view of the seed meter assembly of the research plot planter.

FIG. 4 is a side view of the seed meter tube with a seed drop gate positioned near the outlet to provide a staging area for the seed and a controlled and synchronized seed release based on a GPS-determined position in the field.

FIG. 5 is a side view of the seed meter tube shown in FIG. 4, with the seed drop gate in its open position for releasing a seed from the seed tube.

FIG. 6 is a diagram of a grid pattern of trigger points on a field that are used to trigger the seed drop gates on all of the row units of the planter at the same time as the planter reaches each trigger point.

FIG. 7 is a flowchart diagram showing a planting method according to the present invention in which seed release mechanisms of multiple rows are activated to release seeds from seed delivery structures at the same time to plant seeds in lateral alignment with each other.

### DESCRIPTION OF EMBODIMENTS

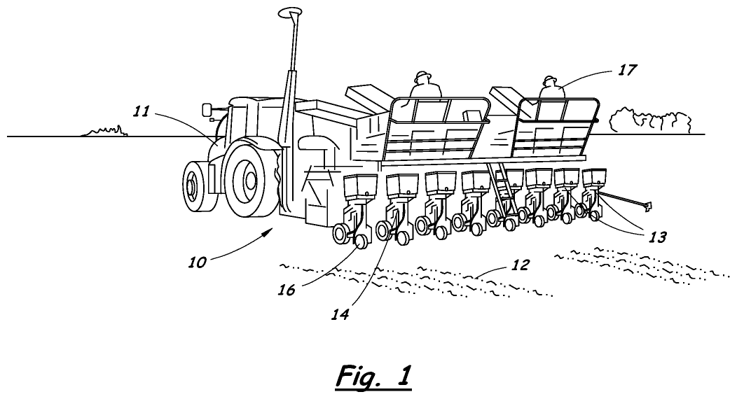

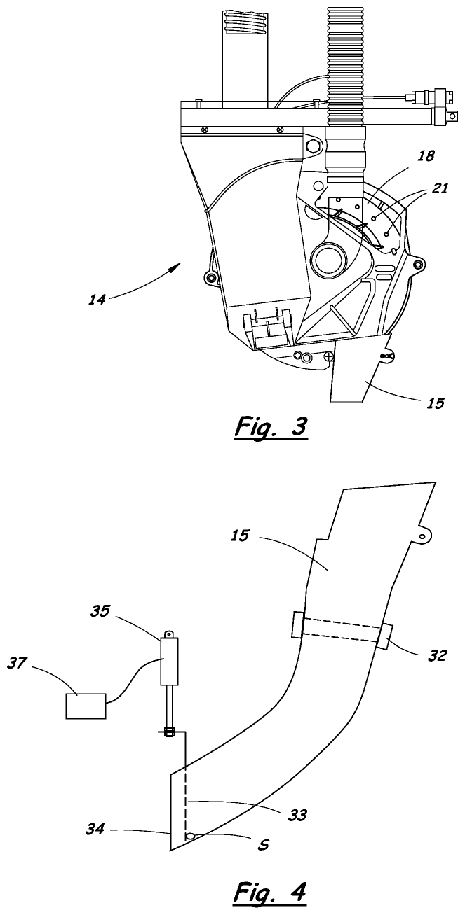

A multi-row planter with synchronized seed drop according to the present invention will now be described with reference to FIGS. 1 to 7 of the accompanying drawings.

FIG. 1 shows a research plot planter 10 being pulled by a tractor 11 through a research plot field 12. The research plot field 12 is typically used by researchers to obtain yield and growth data for different seed types, and therefore contains several individual seed plots, with each plot containing one or more rows and with alleyways separating the end of the rows of one plot from the beginning of the rows of the next plot. For example, the research plot field 12 may have several hundred individual plots separated by alleyways that mark the end of one plot and the beginning of another plot.

The planter 10 shown in FIG. 1 has eight row units 13 that plant eight rows at a time as the planter 10 makes a pass through the field. Each row unit 13 has, among other things, a furrow opener, a seed metering mechanism 14, a seed tube 15 for guiding seeds from the seed metering mechanism 14 into the furrow created by the opener, and a furrow closing assembly 16.

Also shown in FIG. 1 are two researchers 17 seated on the planter 10 to monitor the planter operations and to ensure that the proper seed varieties are loaded into the planter row units 13 for each of the plots.

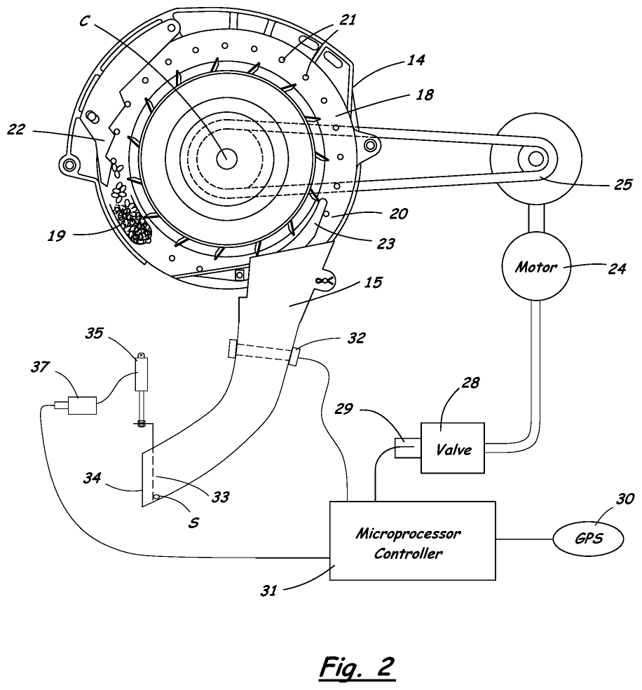

FIG. 2 is a schematic illustration showing some of the components of the planter 10 associated with one planter row unit 13. The seed metering mechanism 14 of the row unit 13 is shown in a cutaway side view with a rotating seed plate 18 that picks up and transports individual seeds from a seed chamber 19 within the seed meter assembly 14 to a release point 20. The seed plate 18 has a plurality of symmetrically spaced apart seed pockets 21 arranged concentric with a center C of the seed plate 18. Each seed pocket 21 has a small hole extending through the seed plate 18 for allowing a vacuum source on the back side of the seed plate 18 to pull seeds into the seed pockets 21 and hold the seeds in the seed pockets 21 until the seeds are released at the release point 20.

As seeds in the seed chamber 19 are picked up on the seed plate 18 there may be multiple seeds on a single seed pocket 21. A singulator element 22 located just above the seed chamber 19 provides a three step progression for gradually rubbing off excess seeds from the seed plate 18 to ensure that only one seed per seed pocket 21 is carried by the seed plate 18.

The seed plate 18 is easily interchangeable with other seed plates so that the size and number of the seed pockets 21 can be matched to the particular seed type being planted. For example, seed plates 18 for planting corn will typically be different than seed plates for planting other crops, such as soybeans.

At the release point 20, the vacuum is cut off and the seeds are released from the seed plate 18 and fall into the seed tube 15, which guides the seeds into a furrow in the earth created by the furrow opener. An ejector element 23 positioned at the release point 20 makes sure the seeds come off of the seed plate 18 at the right time.

A hydraulic drive motor 24 is used for driving the rotation of the seed plate 18 of the seed metering mechanism 14 through a sprocket and chain assembly 25. The same drive motor 24 can be used to drive multiple seed metering mechanisms 14 by extending the drive force across the planter 10 with a rotating shaft and additional sprocket and chain assemblies (not shown). The seed plate 18 of the seed metering mechanism 14 is mounted on a driven shaft connected to the sprocket and chain assembly 25.

The hydraulic drive motor 24 is controlled by a valve 28 that controls the hydraulic flow to the motor 24. The valve 28 allows the rotating speed of the drive motor 24 to be precisely controlled and changed to control the rotational speed and position of the seed plate 18. An electric control element 29, such as a solenoid or other suitable device, is connected to the valve 28 for changing the valve setting to change the hydraulic flow to the motor 24.

A positioning device, such as a GPS device 30, is used to determine a precise location of the planter 10 in the field based on GPS or other available position signals. A microprocessor controller 31 and computer program are used to control the planter functions based on the location of the planter 10 within the field 12. An output from the controller 31 is used to control the electric element 29 associated with the hydraulic valve 28 to control the hydraulic flow to the hydraulic motor 24 for starting and stopping the seed metering mechanism 14.

The present invention can also be used with a conventional row crop planter, rather than a research plot planter 10 as illustrated. Such conventional row crop planters have various forms of seed metering mechanisms, depending on the particular make and model of planter. In either case, the seed metering mechanism 14 is arranged to singulate and drop seeds into a seed delivery structure 15 that guides the seeds from the seed metering mechanism 14 into a furrow created by a furrow opener.

The seed delivery structure can be in the form of a seed tube 15 as shown in the drawings. Alternatively, the seed delivery structure can be in the form of a seed delivery system (not shown) that uses endless belts or brushes to provide controlled seed delivery from the seed metering mechanism down to the seed furrow.

A conventional seed sensor 32 can be provided on the seed tube 15 to detect when seeds fall into the seed tube 15, thereby providing feedback as to whether the correct number of seeds are being dropped by the seed metering mechanism 14 to match the desired seed spacing.

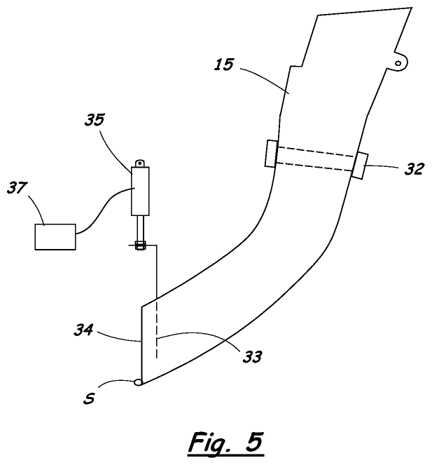

The seed delivery structures 15 each have a respective drop gate 33 adjacent to a lower outlet 34. The drop gate 33 is connected to an actuator 35, such as a linear air cylinder actuator, for selectively moving the seed drop gate 33 between a first closed position (FIG. 4) and a second open position (FIG. 5). In the first closed position, the drop gate 33 blocks the lower outlet 34 of the delivery structure 15. In the second open position, the drop gate 33 allows a seed S or plant to exit from the lower outlet 34 of the seed delivery structure 15.

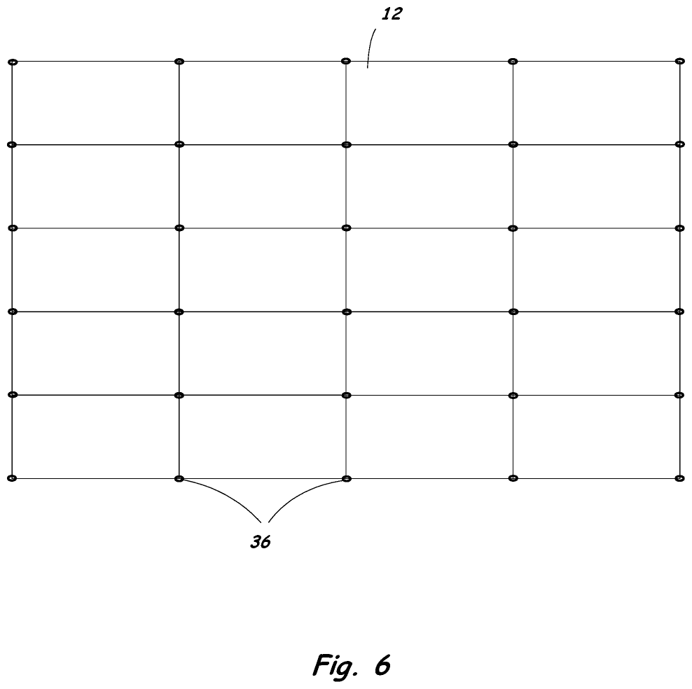

The present invention can be used with a field layout system that allows a user to create a desired field layout with a grid-shaped pattern of rows. As illustrated in FIG. 6, the field layout can include, among other things, a grid pattern of tripping points 36 at selected locations in the field 12, which are used by the controller 31 to determine when to open the seed drop gates 33 of the present invention. The seed drop gates 33 on all of the row units 13 of the planter 10 are opened at the same time by the actuators 34 so that the planted seeds are aligned across the width of the planter 10. This allows the field 12 to be planted with aligned rows in both a longitudinal direction and a lateral direction relative to a direction of planting.

The tripping points 36 created by the field layout system are spaced apart from each other the same distance as the desired spacing between the planted seeds or plants, and are provided for each pass of the planter 10 through the field. The field layout system can be programmed with various parameters, such as the set back distance from the GPS receiver 30 to the point of seed release, so that precise lateral alignment of planted seeds can be achieved for multiple passes through the field in either direction.

The positioning system 30 determines a location of the planter 10 in the field 12 while planting. As the planter 10 reaches the predetermined tripping point locations 36, the controller 31 activates valves 37 that cause the actuators 34 to move the drop gates 33 simultaneously from their first closed positions (FIG. 4) to their second open positions (FIG. 5) to provide a synchronized release of seeds S or plants from all of the row units 13 across the planter 10 at the same time.

During normal planting operations, the seed metering mechanisms 14 operate to singulate and drop seeds into the seed delivery structures 15 at approximately the same seed spacing interval as the spacing between the tripping point locations 36 for activating the release mechanisms 33. Thus, the seeds S are dropped into the seed delivery structures 15 at approximately the same frequency as a frequency in which the seed drop gates 33 are activated, and the seed metering mechanism 14 drops a seed S into the seed delivery structure 15 before each release of the seeds S by the seed drop gates 33. If a particular crop requires multiple seeds to be planted in a single seed drop location, the seed metering mechanisms 14 can be operated at a faster seed drop rate to provide the desired number of seeds to be dropped at each seed drop location.

With the present invention, it does not matter if the seed meter plates 18 of the seed metering mechanisms 14 of separate row units 13 are not aligned or synchronized with each other. For example, the seed S on one row unit 13 may get to its seed drop gate 33 just after the gate 33 closes, the seed S on another row unit 13 may get to its seed drop gate 33 just as the seed drop gate 33 starts to open, and the seed S on yet another row unit 13 may get to its seed drop gate 33 at some other point in between the closing and opening of the seed drop gate 33. All of those seeds will be released by the seed drop gates 33 across the planter 10 at the same time and end up in lateral alignment with each other in their planted position.

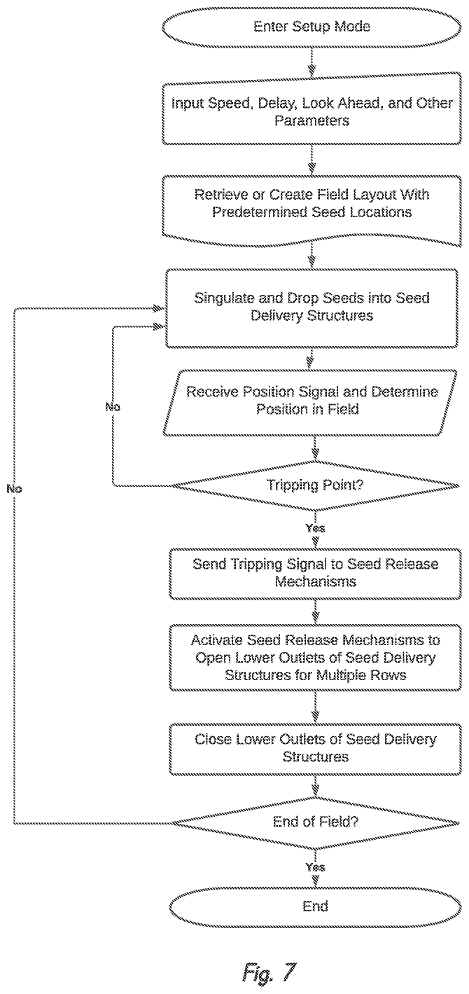

An agricultural planter according to the present invention has been described above. A method of planting according to the present invention will now be described with reference to the flowchart shown in FIG. 7.

The method includes an initial step of inputting various setup parameters, such as speed, delay, look ahead, and so forth so that the controller will activate the seed release mechanisms at the desired locations with the appropriate timing to create laterally aligned rows. Such input parameters are common with other types of GPS control systems, such as sprayer shutoffs, and therefore will not be further described herein.

In addition to inputting setup parameters, the user can retrieve or create a desired field layout with predetermined seed/plant locations. For example, a desired field layout may have a grid pattern of tripping points at 60 inch intervals for each pass of the planter through the field to create a desired 60 inch seed/plant spacing. A single tripping point can be used to activate all of the seed release mechanisms across the width of the planter simultaneously, or separate tripping points for each row unit can be determined using turn compensation techniques or other known control methods to maintain lateral alignment of the planted seeds/plants.

With the input parameters set and the field layout created, the planter is then moved through the field to plant the field. The planter has furrow openers for creating furrows, seed metering mechanisms to singulate and drop seeds, and seed delivery structures to guide the dropped seeds to the furrows.

The GPS system receives position signals to determine the position of the planter in the field. When the planter reaches a predetermined tripping point, a tripping signal is sent to the seed release mechanisms. The seed release mechanisms are then activated to open the seed drop gates at the lower outlets of the seed delivery structures for multiple rows across the width of the planter to provide a synchronized release of seeds or plants from all of the planter row units. As a result, the planted seeds or plants are aligned in a lateral direction relative to the direction of travel of the planter through the field.

The seed drop gates of the seed release mechanisms are then closed and the process repeats as the next tripping point in the field is reached. When the end of the field is reached, the process ends.

The seed metering mechanisms can be set to drop seeds into the delivery structures at a frequency that is approximately the same as a frequency of opening the seed drop gates during planting. For example, if the tripping points for activating the seed release mechanisms are spaced 60 inches apart, the seed metering mechanism can also be set for 60 inch seed spacings.

The aligned grid pattern of the planted seeds in a field provided by the present invention allows the field to be cultivated in both longitudinal and lateral directions relative to the direction traveled by the planter when planting the field. This is particularly advantageous when planting crops, such as hemp, with a desired spacing between plants large enough (e.g., 24″ to 60″) to accommodate a vehicle tire and/or cultivator row unit to allow mechanical cultivation in multiple directions between adjacent plants in the planted rows.

The present invention has been described and illustrated as a seed planter. However, the same inventive concepts of a GPS-controlled release to provide a synchronized and simultaneous drop into laterally aligned rows can also be used with and applied to multi-row planters for placing plants or plant material, such as cuttings, slips, tubers, clones or the like, into the soil. As used herein, the term “planter” is intended to cover all such planter types, and the phrase “seeds or plants” is intended to include seeds, plants and plant material.

While the invention has been described in connection with specific embodiments thereof, it is to be understood that this is by way of illustration and not of limitation, and the scope of the appended claims should be construed as broadly as the prior art will permit.

### INDUSTRIAL APPLICABILITY

The industrial applicability of the present invention is believed to be apparent from the description herein and the nature of the invention. The present invention can be used with agricultural planters to plant seeds, plants or plant material in a grid pattern in a field.

What is claimed is:

1. An agricultural planter, comprising:
a plurality of planter row units spaced across a width of the planter, each row unit comprising a metering mechanism for dropping seeds or plants into a delivery structure that guides the seeds or plants from the metering mechanism into the ground;
said delivery structures each comprising a respective drop gate having a first closed position in which the drop gate blocks a lower outlet of the delivery structure, and a second open position in which the drop gate allows a seed or plant to exit from the lower outlet of the delivery structure;
a positioning system that determines a location of the planter in a field; and
a controller that causes the drop gates of said plurality of planter row units to simultaneously move from their first closed positions to their second open positions to provide a synchronized release of seeds or plants from all of the row units when said positioning system determines that the planter is at a predetermined tripping position in a field.

2. The agricultural planter according to claim 1, wherein said metering mechanism for each row unit comprises a seed metering mechanism that singulates and drops seeds into said delivery structure for guiding the seeds into a furrow created by a furrow opener.

3. The agricultural planter according to claim 2, wherein said delivery structure for each row unit comprises a seed tube having a seed drop gate positioned adjacent to the lower outlet of the seed tube.

4. The agricultural planter according to claim 3, further comprising an actuator associated with the seed drop gate for each row unit for selectively moving the seed drop gate between said first closed position and said second open position.

5. The agricultural planter according to claim 4, wherein said actuator is an air cylinder connected to said seed drop gate.

6. The agricultural planter according to claim 1, wherein said metering mechanism for each row unit comprises a seed metering mechanism that singulates and drops seeds into said delivery structure at a set frequency based on a target seeding rate and actual planter speed, and said seed drop gate for each row unit is moved from said first closed position to said second open position at approximately the same set frequency.

7. The agricultural planter according to claim 1, wherein said delivery structure for each row unit comprises a seed tube and a seed sensor for detecting when a seed falls into said seed tube.

8. The agricultural planter according to claim 1, wherein said delivery structure for each row unit comprises a tube for guiding a plant into the ground, and said drop gate allows the plant to exit from a lower outlet of the tube when the drop gate moves from said first closed position to said second open position.

9. An agricultural planter, comprising:
a plurality of planter row units spaced across a width of the planter, each row unit comprising a furrow opener for creating a furrow, a seed tube for guiding seeds into the furrow, and a seed metering mechanism for singulating and dropping seeds into said seed tube; and
a plurality of seed drop gates arranged to selectively close lower outlets of said seed tubes, said seed drop gates being movable between first closed positions in which the lower outlets are blocked, and second open positions in which the lower outlets are open to allow seeds to exit from the seed tubes.

10. The agricultural planter according to claim 9, further comprising a positioning system that determines when the planter is at a predetermined tripping position in a field so that all of said seed drop gates can be moved to said second open positions simultaneously to provide a synchronized release of seeds from all of the planter row units.

11. The agricultural planter according to claim 9, further comprising a positioning system that determines a location of the planter in a field; and
a controller that causes the seed drop gates of said plurality of planter row units to simultaneously move from their first closed positions to their second open positions to provide a synchronized release of seeds from all of the row units when said positioning system determines that the planter is at a predetermined tripping position in a field.

12. The agricultural planter according to claim 9, further comprising actuators associated with the seed drop gates for selectively moving the seed drop gates between their first closed positions and second open positions.

13. The agricultural planter according to claim 12, wherein said actuators are air cylinders connected to said seed drop gates.

14. The agricultural planter according to claim 9, wherein said seed metering mechanisms are set to drop seeds into said delivery structure at a frequency that is approximately the same as a frequency of opening said seed drop gates during planting.

15. The agricultural planter according to claim 9, wherein said seed tubes comprise seed sensors for detecting when seeds fall into the seed tubes.

16. An agricultural planter, comprising:
a plurality of planter row units spaced across a width of the planter, each row unit comprising a release mechanism for releasing seeds or plants into the ground;
a positioning system that determines a location of the planter in a field; and
a controller that causes the release mechanism to release seeds or plants from the planter row units simultaneously as the planter reaches predetermined locations in the field determined by the positioning system, whereby the seeds or plants from all of the row units are released in a synchronized manner and aligned in a lateral direction relative to a direction of travel of the planter while planting.

17. The agricultural planter according to claim 16, wherein said row units further comprise furrow openers for creating a furrow, seed delivery structures for guiding seeds into the furrow, and seed metering mechanisms for singulating and dropping seeds into the seed delivery structures, and wherein said release mechanisms comprise a plurality of seed drop gates arranged to selectively close lower outlets of said seed delivery structures, said seed drop gates being movable between closed and open positions for selectively releasing seeds from the seed delivery structures, and wherein said seed drop gates are moved to said open positions simultaneously to provide a synchronized release of seeds from all of the planter row units.

18. The agricultural planter according to claim 17, further comprising actuators associated with the seed drop gates for selectively moving the seed drop gates between their closed and open positions.

19. The agricultural planter according to claim 17, wherein said seed metering mechanisms are set to drop seeds into said delivery structure at a frequency that is approximately the same as a frequency of opening said seed drop gates during planting.

20. The agricultural planter according to claim 16, wherein said positioning system comprises a GPS receiver.

21. A method of planting, comprising:
providing a planter having a plurality of planter row units spaced across a width of the planter, each row unit comprising a release mechanism for releasing seeds or plants into the ground;
determining a position of the planter in a field using a positioning system; and
using the release mechanism to release seeds or plants from the planter row units simultaneously as the planter reaches predetermined locations in the field determined by the positioning system, whereby the seeds or plants from all of the row units are released in a synchronized manner and aligned in a lateral direction relative to a direction of travel of the planter while planting.

22. The method of planting according to claim 21, further comprising:
creating furrows using respective furrow openers associated with each row unit;
guiding seeds into the furrows using seed delivery structures;
singulating and dropping seeds into the seed delivery structures using seed metering mechanisms; and
selectively releasing seeds from the seed delivery structures using a plurality of seed drop gates associated with said release mechanisms to selectively open and close lower outlets of said seed delivery structures to provide a synchronized release of seeds from all of the planter row units.

23. The method of planting according to claim 22, further comprising using actuators associated with the seed drop gates to selectively move the seed drop gates between their closed and open positions.

24. The method of planting according to claim 22, further comprising using said seed metering mechanisms to drop seeds into said delivery structure at a frequency that is approximately the same as a frequency of opening said seed drop gates during planting.

25. The method of planting according to claim 21, wherein said positioning system comprises a GPS receiver, and said step of determining a position of the planter in the field comprises using the GPS receiver to receive GPS signals to indicate a position of the planter in the field.
